(19) United States
(12) Patent Application Publication
(10) Pub. No.: US 2013/0160802 A1
(43) Pub. Date: Jun. 27, 2013

(54) PROCESSES AND SYSTEMS FOR REDUCING UNDESIRED DEPOSITS WITHIN A REACTION CHAMBER ASSOCIATED WITH A SEMICONDUCTOR DEPOSITION SYSTEM

(71) Applicant: Ronald Thomas Bertram, JR., Mesa, AZ (US)

(72) Inventor: Ronald Thomas Bertram, JR., Mesa, AZ (US)

(73) Assignee: Soitec, Crolles Cedex (FR)

(21) Appl. No.: 13/720,588

(22) Filed: Dec. 19, 2012

Related U.S. Application Data
(60) Provisional application No. 61/580,092, filed on Dec. 23, 2011.

(51) Int. Cl. B08B 7/00

(52) U.S. Cl. CPC B08B 7/00
USPC 134/39; 134/105

(57) ABSTRACT

Processes and systems are used to reduce undesired deposits within a reaction chamber associated with a semiconductor deposition system. A cleaning gas may be caused to flow through at least one gas flow path extending through at least one gas furnace, and the heated cleaning gas may be introduced into a reaction chamber to remove at least a portion of undesired deposits from within the reaction chamber.

### CROSS-REFERENCE TO RELATED APPLICATION

This application claims the benefit of U.S. Provisional Patent Application Ser. No. 61/580,092, filed Dec. 23, 2011, the disclosure of which is hereby incorporated herein in its entirety by this reference.

### FIELD

Embodiments of the invention generally relate to processes for reducing undesired deposits within a semiconductor deposition system, and systems for performing such processes. More particularly, embodiments of the invention include processes and systems for reducing undesired deposits from within a reaction chamber associated with a semiconductor deposition system.

### BACKGROUND

Deposition system cleanliness is an important parameter in determining the quality of material deposited by such systems. For example, the accumulation of undesirable deposits within a reaction chamber may result in a deterioration of the quality of a material deposited therein.

Deposition systems may include hydride vapor phase epitaxy (HVPE) systems utilized for the deposition of semiconductor materials, such as III-nitrides. In the case of HVPE growth of III-nitride semiconductor materials, the buildup of undesirable deposits within a reaction chamber may be due to the group III precursor (e.g., GaCl) having a high vaporization temperature. Due to the high vaporization temperature of the group III precursor, undesirable deposition may occur on surfaces at temperature below approximately 500° C. The buildup of undesirable deposits within the reaction chamber may necessitate removal of all, or at least a substantial portion of, the undesirable deposits utilizing chamber cleaning processes. Failure to complete reaction chamber cleaning may result in a deterioration of the quality of semiconductor material deposited therein due in part to increased reactor particulates.

Undesirable deposits within the reaction chamber may also have a detrimental effect on the efficiency of the heating and cooling of the associated deposition system. For example, in some deposition systems, the reaction chamber may comprise transparent materials, such as transparent quartz, and heating may be performed by infrared (IR) irradiation from lamp sources passing through the transparent materials. The undesirable deposits on the surfaces of the reaction chamber may be opaque in nature, and may affect the transmission qualities of the reaction chamber. As a result of changes in the optical properties of the quartz chamber, excess heating of the reaction chamber may occur due to IR absorption during the course of a growth cycle.

Systems and methods are therefore desirable to reduce the formation of undesirable deposits within semiconductor deposition systems.

### BRIEF SUMMARY

This summary is provided to introduce a selection of concepts in a simplified form, such concepts being further described in the detailed description below of some example embodiments of the invention. This summary is not intended to identify key features or essential features of the claimed subject matter, nor is it intended to be used to limit the scope of the claimed subject matter.

In some embodiments, the present disclosure includes methods for controlling undesired deposits within a reaction chamber associated with a semiconductor deposition system. The methods of the embodiments may comprise heating a cleaning gas by flowing the cleaning gas through at least one gas flow path extending through at least one gas furnace. Methods may also include introducing the cleaning gas into the reaction chamber through a precursor injector and removing at least a portion of the undesired deposits from within the reaction chamber by reacting the cleaning gas with the portion of the undesired deposits to form a reaction product and exhausting the reaction product from the reaction chamber through an exhaust channel.

Embodiments may also include systems for controlling undesired deposits within a reaction chamber associated with a semiconductor deposition system, such systems may include, a source of cleaning gas, a gas heating apparatus for heating the cleaning gas, the gas heating apparatus comprising at least one gas flow path extending through at least one gas furnace, wherein the at least one gas flow path includes at least one section having a serpentine configuration. The system may also include an at least substantially enclosed reaction chamber defined by a top wall, a bottom wall, and at least one side wall, the reaction chamber being in fluidic communication with the gas heating apparatus.

### BRIEF DESCRIPTION OF THE DRAWINGS

The present disclosure may be understood more fully by reference to the following detailed description of example embodiments, which are illustrated in the appended figures in which:

FIG. 1 is a cut-away perspective view schematically illustrating an example of an embodiment of a deposition system of the invention;

FIG. 2 is an exemplary embodiment of a gas heating apparatus of the invention; and

FIG. 3 is a simplified cut-away perspective view schematically illustrating an example embodiment of a reaction chamber of the invention.

### DETAILED DESCRIPTION

The illustrations presented herein are not meant to be actual views of any particular system, component, or device, but are merely idealized representations that are employed to describe embodiments of the present invention.

As used herein, the teem “III-V semiconductor material” means and includes any semiconductor material that is at least predominantly comprised of one or more elements from group IIIA of the periodic table (B, Al, Ga, In, and Ti) and one or more elements from group VA of the periodic table (N, P, As, Sb, and Bi). For example, III-V semiconductor materials include, but are not limited to, GaN, GaP, GaAs, InN, InP, InAs, AlN, AlP, AlAs, InGaN, InGaP, InGaNP, etc.

As used herein, the term “reaction chamber” means and includes any type of structure defining a generally enclosed space in which a material is to be deposited in a material deposition process.

As used herein, the term “undesirable deposit” means and includes any material deposited on a surface within a reaction chamber on which the material is not intended to be deposited.

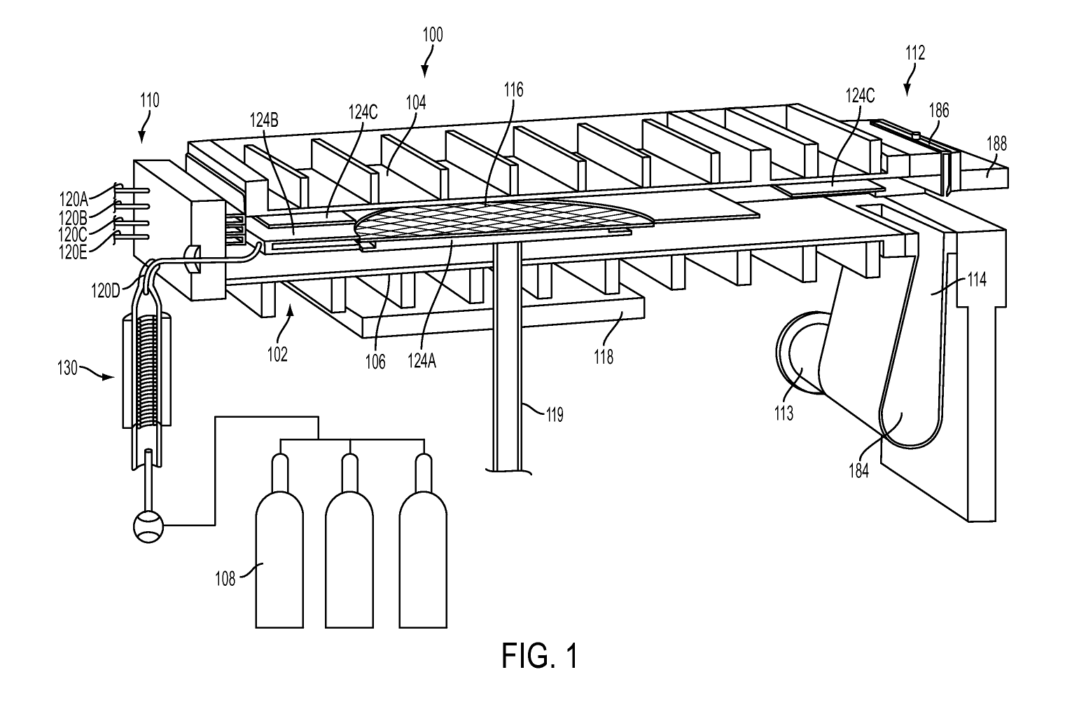

Embodiments of the present invention comprise processes and systems for reducing undesired deposits within a deposition system, and, more specifically, within a semiconductor deposition system. FIG. 1 illustrates a non-limiting example semiconductor deposition system 100 as may be utilized in embodiments of the invention. The semiconductor deposition system 100 may include a reaction chamber 102, wherein the reaction chamber 102 includes a top wall 104, a bottom wall 106, and at least one side wall, which together define an at least substantially enclosed space within the reaction chamber 102.

In non-limiting examples, the semiconductor deposition system 100 may comprise a HVPE semiconductor deposition system utilized for the deposition of III-nitride semiconductors materials, such as, for example gallium nitride, aluminum nitride, indium nitride and alloys thereof. The example HVPE semiconductor deposition system may utilize an internal liquid gallium source for the generation of the group III-precursor as described in U.S. Pat. No. 6,179,913, which issued Jan. 30, 2001 to Solomon et al., the entire disclosure of which patent is incorporated herein by reference. In additional examples, the HVPE semiconductor deposition systems may employ a source of group III-precursor that originates from an external source of a GaCl₃ precursor, which is directly injected into the reaction chamber. Examples of such methods and systems are disclosed in, for example, U.S. Patent Application Publication No. US 2009/0223442 A1, which published Sep. 10, 2009 in the name of Arena et al., the entire disclosure of which publication is incorporated herein by reference.

One or more reaction chamber fixtures 124A-C may be disposed within the reaction chamber. Reaction chamber fixtures 124A-C may include at least one of a substrate support structure 124A (for supporting one or more workpiece substrates 116), a process gas injector 124B (for injecting one or more process gases), and one or more passive heat transfer structures 124C (for providing thermal energy to process gases). The reaction chamber fixtures 124A-C may be fabricated from materials which may be susceptible to the accumulation of undesirable deposits. For example, reaction chamber fixtures 124A-C may be fabricated from materials such as silicon carbide, boron carbide and/or graphite.

During one or more deposition cycles, i.e., during the growth of semiconductor material upon the work piece substrates 116, undesirable deposits may accumulate on surfaces within the semiconductor deposition system 100 other than those on the workpiece substrates 116 on which material is intended to be deposited. For example, undesirable deposits may accumulate within reaction chamber 102 on one or more of the walls of the reaction chamber 102 and/or on one or more of the reaction chamber fixtures 124A-C disposed within the reaction chamber 102. One or more cleaning processes may be performed within the reaction chamber 102 to remove at least a portion of the undesirable deposits from surfaces of one or more of the walls of the reaction chamber 102, and/or from surfaces of one or more reaction chamber fixtures 124A-C disposed within the reaction chamber 102. In other words, the undesirable deposits may be removed from locations within the reaction chamber 102 which have been exposed to semiconductor process gases. Processes and systems for depositing semiconductor materials are briefly described below as they relate to the formation of undesirable deposits within reaction chamber 102.

Deposition of semiconductor materials utilizing a semiconductor deposition system 100 may comprise flowing process gases into the reaction chamber 102 by way of a gas injection device 110. Process gases may flow from gas sources through gas conduits 120A-120E into gas injection device 110, and may then be injected into the reaction chamber 102 through individual gas injectors, such as process gas injector 124B. For deposition purposes, the process gases may include one or more of group III precursor gases, group V precursor gases, carrier gases, dopant gases, etc.

In a non-limiting example deposition cycle, the group III precursor may comprise GaCl₃. The GaCl₃ may flow from gas sources 108 through gas heating apparatus 130, wherein the GaCl₃ is heated. In some embodiments, the GaCl₃ may at least partially decompose within the gas heating apparatus 130. The heated/decomposed GaCl₃ subsequently flows through gas conduit 120D into gas injection device 110 and is injected into the reaction chamber 102 through process gas injector 124B. One or more further process gases, such as one or more group V-precursors (e.g., NH₃), dopants (e.g., silane) and carrier and/or purge gases (e.g., H₂, N₂, Ar) may also be introduced into reaction chamber 102 through gas injection device 110 via gas conduits 120A, 120B, 120C and 120E.

Upon injection of the process gases into reaction chamber 102, the group III precursor and the group V precursor may interact over the heated workpiece substrate 116, supported by substrate support structure 124A. The interaction (e.g., reaction) between the group III precursor and the group V precursor may take place at elevated temperature, for example at temperatures between approximately 500° C. and approximately 1100° C.

The heating for achieving such elevated temperature processes may be provided by the heating elements 118, which may comprise radiant heating lamps configured to radiate infrared energy. The heating elements 118 may be located and configured for imparting radiant energy to the substrate support structure 124A and work piece substrates 116 supported thereon. In additional embodiments, the heating elements 118 may be located above the reaction chamber 102, or may include both heating elements 118 located below the reaction chamber 102 and heating elements located above the reaction chamber 102.

Optionally, further heating of the process gases may be provided by passive heat transfer structures 124C (e.g., structures comprising materials that behave similarly to a black body), which may be located within the reaction chamber 102 to improve transfer of heat to the precursor gases. Passive heat transfer structures may be provided within the reaction chamber 102 as disclosed in, for example, U.S. Patent Application Publication No. US 2009/0214785 A1, which published on Aug. 27, 2009 in the name of Arena et al., the entire disclosure of which is incorporated herein by reference.

By way of example and not limitation, the deposition system 100 may include one or more passive heat transfer structures 124C within the reaction chamber 102, as shown in FIG. 1. These passive heat transfer plates 124C may be generally planar and may be oriented generally parallel to the top wall 104 and the bottom wall 106. In some embodiments, these passive heat transfer structures 124C may be located closer to the top wall 104 than the bottom wall 106, such that they are positioned in a plane vertically above a plane in which the workpiece substrate 116 is disposed within the reaction chamber 102. The passive heat transfer structures 124C may extend across only a portion of the space within the reaction chamber 102, as shown in FIG. 1, or they may extend across substantially the entire space within the reaction chamber 102. In some embodiments, a purge gas may be caused to flow through the reaction chamber 102 in the space between the top wall 104 of the reaction chamber 102 and the one or more passive heat transfer structures 124C so as to reduce unwanted deposition of material on the inner surface of the top wall 104 within the reaction chamber 102. Such a purge gas may be supplied from, for example, the gas inflow conduit 120A. Of course, passive heat transfer structures having configurations other than those of the heat transfer structures 124C of FIG. 1 may be incorporated within the reaction chamber 102 in additional embodiments, and such heat transfer plates may be located in positions other than those at which the heat transfer plates 124C of FIG. 1 are located.

During the deposition processes outlined herein, undesirable deposits may accumulate within reaction chamber 102, such as on surfaces of one or more walls of the reaction chamber 102, and/or on surfaces of the reaction chamber fixtures 124A-C disposed with the reaction chamber 102. The undesirable deposits may form directly on the surfaces of the walls and fixtures associated with the reaction chamber 102, or they may form in the gas phase and be subsequently transported to and deposited on such surfaces.

The undesirable deposits may comprise, for example, products and by-products produced by the reaction between a group III chloride and ammonia. It should be noted that, during deposition processes intended for the deposition of group III nitride materials, the deposition of a group III nitride, such as gallium nitride, at unintended locations within reaction chamber 102 (e.g., when not deposited on work piece substrates 116) may constitute the formation of an undesirable deposit. As non-limiting examples, the undesirable deposits may include one or more of ammonium chloride salts, gallium chloride, gallium, and gallium nitride.

Embodiments of methods described herein include cleaning processes for removing at least a portion of such undesirable deposits within the reaction chamber 102. In general, the cleaning processes may be performed prior to and/or subsequent to deposition cycles performed within the semiconductor deposition system 100.

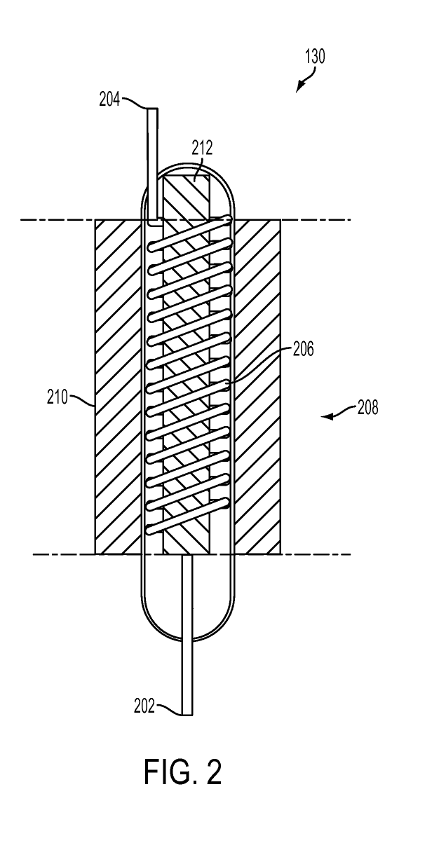

Embodiments of the semiconductor deposition system cleaning processes are described with reference to the exemplary semiconductor deposition system 100 (FIG. 1) and an exemplary gas heating apparatus 130 shown in FIG. 2. Prior to initiating one or more cleaning processes, the semiconductor deposition system 100 may be placed in a pre-clean state. For example the semiconductor deposition system 100 may be placed in a pre-clean state by discontinuing the flow of semiconductor process gases through gas injection device 110, unloading workpiece substrates 116 from the reaction chamber 102, and setting the temperature within the reaction chamber 102 to less than approximately 400° C.

Upon placing the deposition system 100 into a pre-clean state, a cleaning process may proceed. The cleaning process may comprise one or more stages, including a pre-removal stage, a removal stage and a post-removal stage. The cleaning process may end by placing the semiconductor deposition system 100 into a post-clean state.

The pre-removal stage may comprise supplying a source of a cleaning gas to the reaction chamber 102 and heating the cleaning gas by flowing the cleaning gas through the gas heating apparatus 130. The cleaning gas may comprise a single cleaning gas or a combination of cleaning gases and may be supplied from one or more of the gas sources 108. The cleaning gas may have a composition selected for its ability to react with undesired deposits on surfaces within the reaction chamber 102 to form one or more reaction products (e.g., gases, vapors, or solid particulates that may be carried within gases or vapors) that may be removed from reaction chamber 102 through an exhaust channel 114 of an exhaust system 184. In particular, the cleaning gas should not leave residues that can contaminate semiconductor material to be deposited on workpiece substrates 116 in subsequent deposition cycles, or that may lead to damage of the reaction chamber 102. For example, the cleaning gas can be selected to (thermodynamically) force the dissolution of undesired deposits.

In some embodiments of the cleaning processes, the cleaning gas may comprise a halogen. For example, the cleaning gas may comprise one or more gaseous species that include chlorine and/or fluorine. When utilizing a gas containing chlorine, the chlorine containing gas may comprise one or more of chlorine (e.g., Cl, Cl₂) and/or gaseous hydrochloric acid (HCl). In addition to the halogen containing gas, the cleaning gas may also include a further component gas. For example, such a further component gas may comprise hydrogen gas.

Heating of the cleaning gas may be provided by gas heating apparatus 130. As illustrated in FIG. 1, in one example embodiment, the gas heating apparatus 130 may be disposed external to the reaction chamber 102, although in some embodiments the gas heating apparatus may be disposed internal to the reaction chamber 102 or even partially within the reaction chamber 102. An example of a gas heating apparatus that may be utilized in the methods of the invention has been described in detail in, for example, U.S. patent application Ser. No. 61/157,112, which was filed Mar. 3, 2009 by Arena et al, which is incorporated herein, in its entirety, by this reference for all purposes.

Referring to FIG. 2, the gas heating apparatus 130 may include a gas inlet port 202 and a gas outlet port 204, and a gas flow path 206 extends through the gas heating apparatus 130 between the gas inlet port 202 and the gas outlet port 204 through a conduit (e.g., a tube). The gas flow path 206 extends through a gas furnace 208, which is utilized to supply thermal energy to the cleaning gas flowing through the gas flow path 206.

The gas flow path 206 may be configured such that it includes at least one section having a coil configuration, as illustrated in FIG. 2. A coil configuration may be utilized for the gas flow path 206, such that the gas flow path length between the gas inlet port 202 and the gas outlet port 204 is longer than the actual physical distance between the gas inlet port 202 and the gas outlet port 204. Increasing the physical distance between the gas inlet port 202 and the gas outlet port 204 may increase the residence time of the cleaning gas through gas furnace 208 thereby improving the heating capacity of the gas furnace 208. Configurations other than coil configurations also may be employed, such as serpentine-shaped configurations for example.

The gas furnace 208 may include active and passive heating elements for supplying thermal energy to the cleaning gas. For example, the gas furnace 208 may include one or more active heating elements 210, which may be disposed proximate to the gas flow path 206. The active heating elements 210 may include, for example, one or more of resistive heating elements, radiant heating elements, and radio frequency heating elements. The gas furnace 208 may also include passive heating elements, such as, for example, passive heating element 212, which may comprise a black body structure, e.g., a rod comprising a black body material (e.g., silicon carbide) that re-radiates heat. As shown in FIG. 2, the gas flow path 206 may extend around (e.g., in a coil) the passive heating element 212 in some embodiments.

The gas heating apparatus 130 may be utilized to provide thermal energy to the cleaning gas to improve the efficiency of removal of undesired deposits from the deposition system 100. For example, in some embodiments, the cleaning gas may be heated using the gas heating apparatus 130 to a temperature of approximately 600° C. or more, to a temperature of approximately 800° C. or more, or even to a temperature of approximately 1000° C. or more.

After heating the cleaning gas using the gas heating apparatus 130, the cleaning gas may be introduced into the reaction chamber 102 through a precursor gas injector 124B. The removal stage of the gas-cleaning process involves utilizing the heated cleaning gas to remove undesirable deposits from within reaction chamber 102, e.g., from surfaces of one or more walls of the reaction chamber 102, and/or from surfaces of one or more reaction chamber fixtures 124A-C disposed within reaction chamber 102. In some embodiments, the removal stage of the cleaning process comprises removing at least a portion of undesired deposits from within the reaction chamber 102 by reacting the cleaning gas with the undesired deposits to form one or more reaction products, and exhausting the one or more reaction products from the reaction chamber 102 through an exhaust channel 114.

The removal stage of the cleaning process may include a single removal phase or multiple removal phases, each of which may comprise similar or different cleaning gas chemistries, which may be tailored from removal of different types of deposits. For example, in some embodiments, the removal stage may include a removal phase for removing a portion of the undesired deposits preferentially from a first zone within the reaction chamber, and a removal phase for removing a portion of the undesired deposits preferentially from a second zone within the reaction chamber.

Referring again to FIG. 1, the removal stage may commence by introducing the heated cleaning gas into the reaction chamber 102 through the precursor gas injector 124B, which is in fluidic communication with gas injection device 110, which is in turn coupled to the gas outlet port 204 of the gas heating apparatus 130.

The removal stage of the cleaning process may include selecting the cleaning gas to comprise a gaseous mixture of hydrogen gas and gaseous hydrochloric acid. The flow rate of the hydrogen gas during the removal stage of the cleaning process may be between approximately 1 slm and approximately 30 slm, between approximately 1 slm and approximately 15 slm, or even between approximately 1 slm and approximately 10 slm for a reaction chamber 102 having a volume of between about 10 sl and about 100 sl. The flow rate of the gaseous hydrochloric acid during the removal stage of the cleaning process may be between approximately 1 slm and approximately 100 slm, between approximately 1 slm and approximately 50 slm, or even between approximately 1 slm and approximately 30 slm for a reaction chamber 102 having a volume of between about 10 sl and about 100 sl.

The pressure within the reaction chamber 102 may also be utilized as a parameter in controlling the efficiency of the removal of undesired deposits from within the reaction chamber 102 during the removal stage of the cleaning process. For example, during the removal stage of the cleaning process, the pressure with the reaction chamber 102 may be between approximately 1 Torr and approximately 800 Torr, between approximately 200 Torr and approximately 760 Torr.

In addition to controlling the pressure within the reaction chamber 102, the temperature within the reaction chamber 102 may also be controlled to improve the efficiency of removal of undesired deposits from within reaction chamber 102 during the removal stage of the cleaning process. For example, the reaction chamber may be maintained at a temperature or temperatures between approximately 600° C. and approximately 800° C., between approximately 600° C. and approximately 1000° C., or even between approximately 600° C. and approximately 1200° C., during the removal stage of the cleaning process.

As previously described herein, in some embodiments of the cleaning processes, the removal stage may include two or more removal phases. The two or more removal phases may be utilized for preferentially removing undesirable deposits from different zones within the reaction chamber 102. Each of the two or more removal phases may be established by varying one or more of the cleaning process parameters (e.g., reactor pressure, reactor temperature, cleaning gas composition, cleaning gas flow rates, etc.) For example, a removal phase may be utilized for removing a portion of the undesired deposits preferentially from a first zone within the reaction chamber 102, and a subsequent removal phase may be utilized for removing a portion of the undesired deposits preferentially from a second zone within the reaction chamber 102.

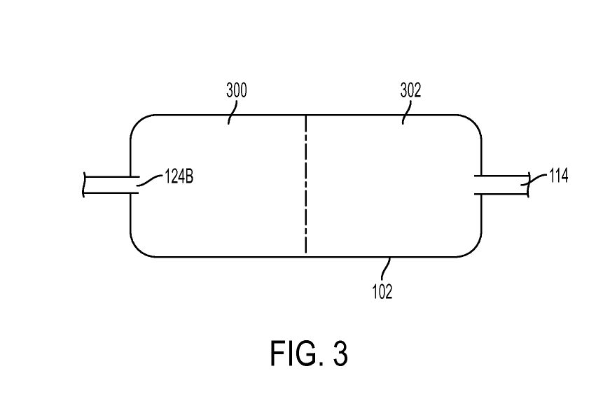

In greater detail, FIG. 3 illustrates a simplified cross sectional view of an exemplary reaction chamber 102 associated with the semiconductor deposition system 100. As a non-limiting example of a cleaning process comprising two or more removal phases, the cleaning process may include a removal phase which may be utilized for removing a portion of the undesired deposits preferentially from a first zone 300 within the reaction chamber 102. As illustrated in FIG. 3, the first zone 300 may be disposed within reaction chamber 102 more proximate to the precursor gas injector 124B than to the exhaust channel 114. In other words, during one removal phase, undesired deposits may be preferentially removed from locations more proximate to the point of injection of the cleaning gas into the reaction chamber 102 relative to locations more proximate to the point of removal of the reaction product or products from the reaction chamber 102.

In some embodiments, a removal phase that may be utilized for removing at least a portion of the undesired deposits preferentially from a first zone 300 within the reaction chamber 102 may comprise selecting a set of cleaning process parameters. As a non-limiting example, this removal phase of the cleaning process may comprise selecting a pressure within the reaction chamber to be between approximately 300 Torr and approximately 760 Torr, selecting a hydrogen gas flow rate to be between approximately 1 slm and approximately 10 slm, and further selecting a gaseous hydrochloric acid flow rate to be between approximately 1 slm and approximately 10 slm.

A subsequent removal phase may be utilized for removing at least a portion of the undesired deposits preferentially from a second zone 302 within the reaction chamber 102. The second zone 302 may be disposed more proximate to the exhaust channel 114 than to the precursor gas injector 124B. In other words, during the removal phase, undesired deposits may be preferentially removed from locations more proximate to the point of removal of the reaction product or products from the reaction chamber 102 relative to the point of injection of the cleaning gas into the reaction chamber 102.

In some embodiments, a removal phase that may be utilized for removing at least a portion of the undesired deposits preferentially from a second zone 302 within the reaction chamber 102 may comprise selecting a further, different set of cleaning process parameters. As a non-limiting example, this removal phase of the cleaning process may comprise selecting a pressure within the reaction chamber to be between approximately 200 Torr and approximately 800 Torr, selecting a hydrogen gas flow rate to be between approximately 1 slm and approximately 10 slm, and further selecting a gaseous hydrochloric acid flow rate to be between approximately 10 slm and approximately 30 slm.

The progress of the one or more removal stages may be monitored so that cleaning may be interrupted automatically, without operator delay, when the reaction chamber 102 associated with the semiconductor deposition system 100 is sufficiently clean. Such monitoring of the cleaning process may be provided by monitoring or by sensing the optical properties of the reaction chamber walls, and/or by sampling the composition of the gases exhausted from the reaction chamber 102 during the cleaning process.

Once the reaction chamber 102 is deemed sufficiently clean, the removal stage may be complete. Upon completion of the removal stage, the post-removal stage may commence. For example, the post-removal stage may be utilized to remove at least a portion of the residual cleaning gas from within the reaction chamber 102 after removing at least a portion of the undesired deposits from within the reaction chamber 102. In some embodiments, at least a portion of the residual cleaning gas may be removed from within the reaction chamber 102 by purging the reaction chamber 102 one or more times. Purging the reaction chamber 102 may include at least one of purging the reaction chamber with an inert gas and purging the reaction chamber with an active gas.

As noted, the post-removal stage of the cleaning process may be utilized to remove residual cleaning gas from the reaction chamber 102 so that the cleanliness of the reaction chamber 102 may be restored to an acceptable level for further deposition cycles. Exemplary purge stages may include, in no particular order, a high temperature inert gas purge and a high temperature active gas purge, as discussed in further detail below. These purge stage or stages may be repeated one or more times until the reaction chamber 102 is deemed sufficiently free of residual cleaning gas, such as gases comprising chlorine.

In some embodiments, a high temperature inert gas purge may comprise introducing hydrogen gas into the reaction chamber 102 and raising the temperature within the reaction chamber for a period of time. In greater detail, hydrogen gas may flow into the reaction chamber 102 at a flow rate of between approximately 5 slm and approximately 50 slm, and the temperature within the reaction chamber 102 may be increased approximately 600° C. or more, approximately 800° C. or more, or even approximately 1200° C. or more. The high temperature inert gas purge may continue for a time period of between approximately 1 minute and approximately 10 minutes.

In some embodiments, a high temperature active gas purge may comprise introducing ammonia gas into the reaction chamber 102 and raising the temperature within the reaction chamber for a period of time. In greater detail, ammonia gas may flow into the reaction chamber 102 at a flow rate of between approximately 1 slm and approximately 20 slm, and the temperature within the reaction chamber 102 may be increased to approximately 600° C. or more, approximately 800° C. or more, or even approximately 1200° C. or more. The high temperature active gas purge may continue for a time period of between approximately 1 minute and approximately 10 minutes.

Upon completion of the purge stages of the cleaning process, the deposition system 100 may be placed into a post-clean state. For example, a post-clean state for the deposition system 100 may include loading workpiece substrates 116 into the reaction chamber 102 and setting the temperature within reaction chamber 102 to less than 400° C. Such a post-clean state may be utilized to prepare the deposition system 100 for subsequent semiconductor material deposition cycles.

The embodiments of the invention described above do not limit the scope of the invention, since these embodiments are merely examples of embodiments of the invention, which is defined by the scope of the appended claims and their legal equivalents. Any equivalent embodiments are intended to be within the scope of this invention. Indeed, various modifications of the invention, in addition to those shown and described herein, such as alternate useful combinations of the elements described, will become apparent to those skilled in the art from the description. Such modifications are also intended to fall within the scope of the appended claims.

What is claimed is:

1. A method for reducing undesired deposits within a reaction chamber associated with a semiconductor deposition system, the method comprising:
heating a cleaning gas by flowing the cleaning gas through at least one gas flow path extending through at least one gas furnace;
introducing the cleaning gas into the reaction chamber through a process gas injector; and
removing at least a portion of the undesired deposits from within the reaction chamber by reacting the cleaning gas with the portion of the undesired deposits to form at least one reaction product and exhausting the at least one reaction product from the reaction chamber.

2. The method of claim 1, further comprising selecting the cleaning gas to comprise one or more of a chlorine containing gas and hydrogen gas.

3. The method of claim 2, further comprising selecting the chlorine containing gas to comprise one or more of elemental chlorine (Cl), chlorine gas (Cl₂), and hydrochloric acid.

4. The method of claim 1, wherein flowing the cleaning gas through the at least one gas flow path extending through at least one gas furnace further comprises flowing the cleaning gas through at least one gas flow path section having a coil configuration.

5. The method of claim 1, further comprising heating the cleaning gas to a temperature of approximately 600° C. or more.

6. The method of claim 1, wherein removing a least a portion of undesired deposits further comprises:
removing a portion of the undesired deposits preferentially from a first zone within the reaction chamber in a first cleaning stage; and
subsequently removing a portion of the undesired deposits preferentially from within second zone of the reaction chamber in a second cleaning stage.

7. The method of claim 6, wherein removing a portion of the undesired deposits preferentially from a first zone of the reaction chamber comprises:
selecting a pressure within the reaction chamber to be between approximately 300 Torr and approximately 760 Torr;
selecting a hydrogen flow rate into the reaction chamber to be between approximately 1 slm and approximately 10 slm; and
selecting a hydrochloric acid flow rate into the reaction chamber to be between approximately 1 slm and approximately 10 slm.

8. The method of claim 6, wherein removing a portion of the undesired deposits preferentially from a second zone of the reaction chamber comprises:
selecting a pressure within the reaction chamber to be between approximately 200 Torr and approximately 800 Torr;
selecting a hydrogen flow rate into the reaction chamber to be between approximately 1 slm and approximately 10 slm; and
selecting a hydrochloric acid flow rate into the reaction chamber to be between approximately 10 slm and approximately 30 slm.

9. The method of claim 6, wherein removing a portion of the undesired deposits preferentially from a first zone within the reaction chamber comprises preferentially removing a portion of the undesired deposits disposed more proximate to the process gas injector than to an exhaust channel of the reaction chamber.

10. The method of claim 6, wherein removing a portion of the undesired deposits preferentially from a second zone within the reaction chamber comprises preferentially removing a portion of the undesired deposits disposed more proximate to an exhaust channel of the reaction chamber than to the process gas injector.

11. The method of claim 1, further comprising removing at least a portion of a residual cleaning gas from within the reaction chamber after removing at least a portion of the undesired deposits from within the reaction chamber.

12. The method of claim 11, wherein removing at least a portion of the residual cleaning gas from within the reaction chamber further comprises purging the reaction chamber one or more times, wherein purging the reaction chamber one or more times includes purging the reaction chamber with at least one of an inert gas and an active gas.

13. The method of claim 12, wherein purging the reaction chamber with at least one of an inert gas and an active gas comprises purging the reaction chamber with at least one of hydrogen and ammonia.

14. The method of claim 12, wherein purging the reaction chamber one or more times comprises:
flowing an inert gas into the reaction chamber at a flow rate of approximately 5 slm or more; and
heating the inert gas to a temperature of approximately 600° C. or more.

15. The method of claim 12, wherein purging the reaction chamber one or more times comprises:
flowing an active gas into the reaction chamber at a flow rate of approximately 1 slm or more; and
heating the active gas to a temperature of approximately 600° C. or more.

16. A system for controlling undesired deposits within a reaction chamber associated with a semiconductor deposition system, the system comprising:
a source of cleaning gas;
a gas heating apparatus for heating the cleaning gas coupled with the source of cleaning gas, the gas heating apparatus comprising at least one gas flow path extending through at least one gas furnace and
an at least substantially enclosed reaction chamber defined by a top wall, a bottom wall, and at least one side wall, the reaction chamber being in fluidic communication with the gas heating apparatus.

17. The system of claim 16, wherein the source of cleaning gas comprises one or more of a chlorine containing gas and hydrogen gas.

18. The system of claim 16, wherein the gas heating apparatus is disposed external to the reaction chamber.

19. The system of claim 16, wherein the gas heating apparatus comprises:
a gas inlet;
a gas outlet; and
a gas flow pathway extending from the gas inlet to the gas outlet;
wherein the gas flow pathway has a length greater than a shortest distance between the gas inlet and the gas outlet.

20. The system of claim 19, wherein the gas flow pathway has a coiled configuration.

21. The system of claim 19, wherein the gas heating apparatus further comprises at least one heating element disposed proximate to the gas flow pathway, the at least one heating element comprising an active heating element selected from the group consisting of a resistive heating element, an inductive heating element, and a radiant heating element.
